(19) United States
(12) Patent Application Publication
(10) Pub. No.: US 2020/0255012 A1
(43) Pub. Date: Aug. 13, 2020

(54) Driving Control Apparatus for Vehicle

(71) Applicant: SUZUKI MOTOR CORPORATION, Hamamatsu-shi (JP)

(72) Inventor: Katsuhiko SATO, Hamamatsu-shi (JP)

(21) Appl. No.: 16/783,912

(22) Filed: Feb. 6, 2020

(30) Foreign Application Priority Data
Feb. 8, 2019 (JP) 2019-021771

(51) Int. Cl. B60W 30/16; B60W 60/00; G05D 1/00

(52) U.S. Cl. CPC B60W 30/162; B60W 2050/0072; G05D 1/0061; B60W 60/0053

(57) ABSTRACT

An ACC function for performing constant speed cruise according to a target speed when there is no preceding other vehicle in a vehicle's driving lane and performing following cruise by maintaining a predetermined inter-vehicle distance when there is a preceding other vehicle, an LKA function for maintaining cruise, an override function for stopping the ACC function and the LKA function by a driver's operation intervention, and a function for performing fallback control of the LKA function, with notifying the driver of ACC function stop, LKA function stop advance notice, and operation takeover, at a time of system limit of the ACC function, LKA override threshold values serving as a determination criterion of the operation intervention for stopping the LKA function at the time of system limit of the ACC function are configured to be altered to a value greater than during normal operation when the ACC function is within the system limit.

### FIELD OF THE INVENTION

The present invention relates to a driving control apparatus for a vehicle, and more particularly, relates to an override function in a partially automated in-lane driving system.

### DISCUSSION OF THE RELATED ART

A variety of techniques for reducing burdens on drivers and for safe-driving support, for example, adaptive cruise control systems (ACCS) and lane keeping assistance systems (LKAS), have been put into practical use. Furthermore, the practical application and international standardization of a “partially automated in-lane driving system (PADS)” based on these techniques are being promoted.

Such a driving control system is only for the purpose of driving support and is different from completely automatic driving. A driver is required to place both hands on the steering wheel and keep track of the driving situation so as to be able to manually drive at any time, the driver needs to respond in accordance with the situation, and the driving control system has an override function that switches to manual driving by the driver's operation intervention even while the system is operating. Patent Literature 1 discloses a vehicle lateral movement control device that determines change speed (fallback speed) of a fallback control amount to shift to manual driving according to change speed of a steering operation amount input by a driver.

In JP 2012-096569 A, if the change in speed of the steering operation amount is large, it is regarded as steering intervention intended by the driver and driving is shifted to manual driving in a short time, and if the change in speed of the steering operation amount is small, fallback control is performed relatively taking more time, and driving is shifted to manual driving. However, the large change in speed of the steering operation amount does not necessarily mean steering intervention intended by the driver, nor does fallback control corresponding to the change in speed of the steering operation amount necessarily mean control suitable for the movement state of the vehicle.

For example, while a partially automated in-lane driving function is operating, if system limit of the ACCS is reached caused by deceleration of a preceding vehicle or cutting-in of a vehicle driving in a neighboring lane, a driving path curvature with respect to vehicle speed reaching a control limit value, activation of the ESP on a slippery road surface, or the like, the ACC function is stopped at the same time as the system limit, and LKA shifts to a fallback control mode. At this time, the driver is notified of a steering and braking/driving operation takeover request (takeover request) together with ACC function stop, and LKAS fallback control is started after the elapse of several seconds.

It may be assumed that behavior of the vehicle becomes unstable when the driver who is overwhelmed by the ACC function stop notice, LKA function stop advance notice, and steering and braking/driving operation takeover request notice performs excessive steering operation, and causes LKA override.

For example, as shown in FIG. 5, if ACCS system limit is reached due to cutting-in of a vehicle 4 that was driving in a neighboring lane 53 during the operation of the partially automated in-lane driving function of a vehicle 1 driving in a lane 52, the driver is notified of the ACC function stop and the steering and braking/driving takeover request, and if the driver who is overwhelmed by the notification performs excessive left steering (OL) or excessive right steering (OR) to cause LKA override, the vehicle may depart from the lane 52 in which the vehicle is driving. At this time, if there is another vehicle behind in the vehicle's lane or neighboring lanes, for example, if there is a vehicle behind 3 in the neighboring lane 53 on the right side as shown, the above-described lane departure may induce deceleration or a lane change of the vehicle behind 3.

Furthermore, as shown in FIG. 6, also in cases such as if a curvature of a curve 1/R with respect to vehicle speed reaches the system limit during the operation of the partially automated in-lane driving function, the driver is notified of the ACC function stop and the steering and braking/driving takeover request, and if the driver who is overwhelmed by the notification performs excessive additive steering (OR) or excessive subtractive steering (OL) to cause LKA override, lane departure or meandering may be induced.

### SUMMARY OF THE INVENTION

The present invention has been made in view of the above-described actual situation, and an object is to provide a driving control apparatus for a vehicle that prevents lane departure, induction of deceleration or lane change of other vehicles, meandering of the vehicle, and the like due to excessive steering intervention during a transition process to LKA fallback control at the time of ACC system limit.

In order to solve the above-described problems, an embodiment of the present invention is directed to

a driving control apparatus for a vehicle, including:

an environmental condition estimating part including a surrounding recognition function for recognizing a vehicle's driving lane and other vehicles driving in the driving lane and a function for obtaining the vehicle's moving state;

a path generating part for generating a target path on the basis of information obtained by the environmental condition estimating part; and

a vehicle control part configured to perform speed control for keeping a preset target speed or target inter-vehicle distance with a preceding other vehicle and steering control for causing the vehicle to follow the target path, and having:

an ACC function for performing constant speed cruise according to the target speed when there is no preceding other vehicle in the vehicle's driving lane and performing following cruise by maintaining the predetermined inter-vehicle distance when there is a preceding other vehicle;

an LKA function for maintaining cruise in the vehicle's driving lane by following control to the target path;

an override function for stopping the ACC function and the LKA function by a driver's operation intervention; and

a function for performing fallback control of the LKA function, with notifying the driver of ACC function stop, LKA function stop advance notice, and operation takeover, at a time of system limit of the ACC function,

characterized in that LKA override threshold values serving as a determination criterion of the operation intervention for stopping the LKA function at the time of system limit of the ACC function are configured to be altered to a value greater than during normal operation when the ACC function is within the system limit.

According to the driving control apparatus for the vehicle according to the present invention, because the override threshold value serving as the determination criterion of the operation intervention at the time of system limit of the ACC function is altered to a value greater than during normal operation when the ACC function is within the system limit, if a driver who is overwhelmed by ACC function stop, LKA function stop advance notice, and operation takeover notice performs excessive operation intervention, override can be avoided, which enables shift to fallback control of the LKA function, can prevent lane departure, induction of deceleration or lane change of other vehicles, meandering of the vehicle, and the like due to excessive operation intervention, and is advantageous in smooth operation takeover.

### BRIEF DESCRIPTION OF DRAWINGS

FIG. 1 is a schematic view showing a driving control system of a vehicle.

FIG. 2 is a schematic plan view showing an external sensor group of the vehicle.

FIG. 3 is a block diagram showing the driving control system of the vehicle.

FIG. 4 is a flowchart showing excessive additive/subtractive steering override prevention control at the time of ACC system limit.

FIG. 5 is a schematic plan view exemplifying lane departure due to excessive steering override at a time of ACC system limit by cutting-in of a vehicle driving in a neighboring lane.

FIG. 6 is a schematic plan view exemplifying lane deviation due to excessive steering override at a time of curve curvature ACC system limit.

### DETAILED DESCRIPTION OF THE PREFERRED EMBODIMENTS

Hereinafter, an embodiment of the present invention will be described in detail with reference to the drawings.

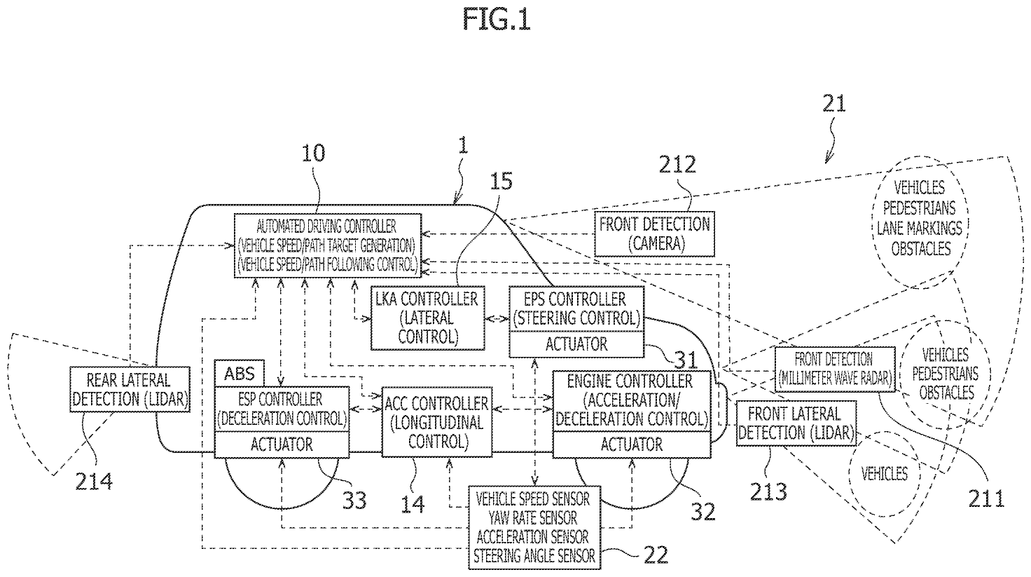

In FIG. 1, a vehicle 1 equipped with a driving control system according to the present invention includes, in addition to common components, such as an engine and a vehicle body, of an automobile, an external sensor 21 for detecting a vehicle surrounding environment, an internal sensor 22 for detecting vehicle information, a controller/actuator group for speed control and steering control, an ACC controller 14 for inter-vehicle distance control, an LKA controller 15 for lane keeping support control, and an automated driving controller 10 for controlling them and performing path following control in order to perform, at the vehicle side, recognition, determination, and operation conventionally performed by a driver.

The controller/actuator group for speed control and steering control includes an EPS (Electric Power Steering) controller 31 for steering control, an engine controller 32 for acceleration/deceleration control, and an ESP/ABS controller 33. An ESP (registered trademark; Electronic Stability Program) includes an ABS (Antilock Brake System) to form a stability control system (vehicle behavior stabilization control system).

The external sensor 21 is composed of a plurality of detection means for inputting lane markings on a road defining the vehicle's own driving lane and the neighboring lane, and presence of and relative distance from other vehicles, obstacles, people, and the like around the vehicle into the automated driving controller 10 as image data or point cloud data.

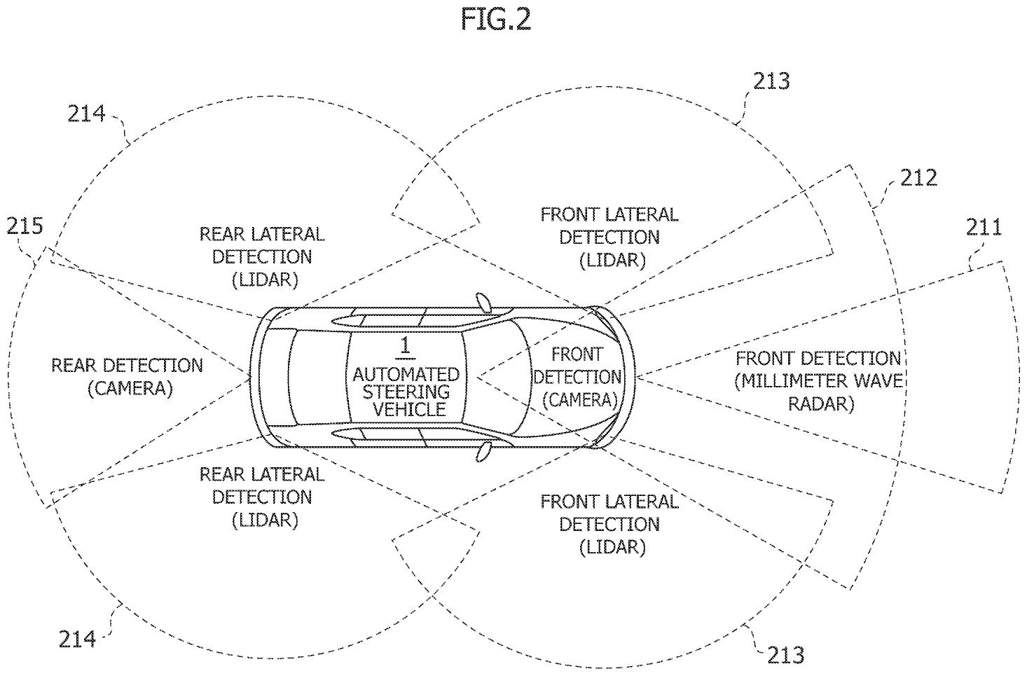

For example, as shown in FIG. 2, the vehicle 1 includes a millimeter wave radar (211) and a camera (212) as forward detection means 211 and 212, LIDARs (Laser Imaging Detection And Ranging) as front lateral direction detection means 213 and rear lateral direction detection means 214, and a camera (back camera) as rearward detection means 215, covers 360 degrees around the vehicle, and can detect positions of and distance from vehicles, obstacles and the like, and lane marking positions within a predetermined distance in the front, rear, left, and right directions of the vehicle.

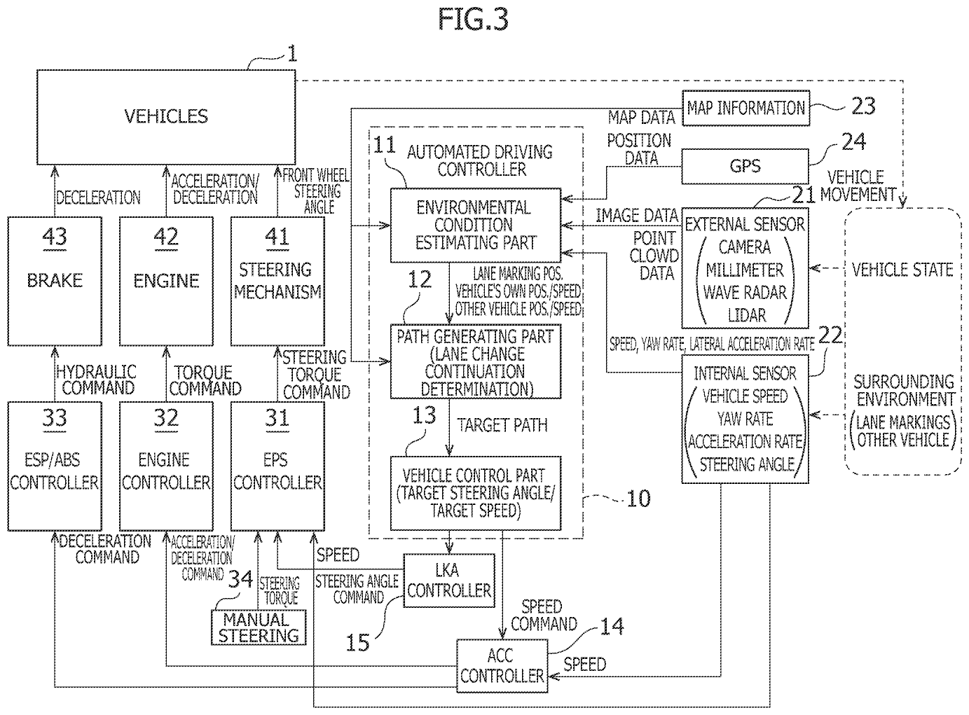

The internal sensor 22 is composed of a plurality of detection means, such as a vehicle speed sensor, a yaw rate sensor and an acceleration sensor, for measuring physical quantities representing the movement state of the vehicle, and their measurement values are input into the automated driving controller 10, ACC controller 14, LKA controller 15, and EPS controller 31 as shown in FIG. 3.

The automated driving controller 10 includes an environmental condition estimating part 11, a path generating part 12 and a vehicle control part 13, and includes a computer for performing functions as described below, that is, a ROM storing programs and data, a CPU for performing arithmetic processing, a RAM for reading out the programs and data, and storing dynamic data and arithmetic processing results, an input/output interface, and the like.

The environmental condition estimating part 11 acquires the absolute position of the vehicle itself by using positioning means 24 such as a GPS, and on the basis of external data such as the image data and point cloud data obtained by the external sensor 21, estimates positions of lane markings of the vehicle's own driving lane and the neighboring lane, and positions and speeds of other vehicles. In addition, it acquires the movement state of the vehicle itself from internal data measured by the internal sensor 22.

The path generating part 12 generates a target path from the vehicle's own position estimated by the environmental condition estimating part 11 to an arrival target. It refers to map information 23 and generates a target path from the vehicle's own position to an arrival target point in lane change on the basis of the positions of the lane markings of the neighboring lane, the positions and speeds of the other vehicles, and the movement state of the vehicle itself estimated by the environmental condition estimating part 11.

The vehicle control part 13 calculates a target speed and a target steering angle on the basis of the target path generated by the path generating part 12, transmits a speed command for constant speed cruise or inter-vehicle distance keeping and following cruise to the ACC controller 14, and transmits a steering angle command for path following to the EPS controller 31 via the LKA controller 15.

The vehicle speed is also input into the EPS controller 31 and ACC controller 14. Because a steering torque changes according to the vehicle speed, the EPS controller 31 refers to a steering angle-steering torque map for each vehicle speed and transmits a torque command to a steering mechanism 41. The engine controller 32, ESP/ABS controller 33, and EPS controller 31 control an engine 42, a brake 43, and the steering mechanism 41, and thereby control movement of the vehicle 1 in a longitudinal direction and a lateral direction.

### Outline of Partially Automated In-Lane Driving System

Next, an outline of a partially automated in-lane driving system (PADS) will be explained on the assumption of traveling within a single lane while following a vehicle ahead on a highway.

Partially automated in-lane driving (PADS driving) is enabled in a state in which both ACC controller 14 included in the ACCS and LKA controller 15 included in the LKAS are operating together with the automated driving controller 10.

At the same time as operation of the partially automated in-lane driving system, the automated driving controller 10 (path generating part 12) generates a target path within a single lane and a target speed on the basis of the external information (lanes, vehicle position, and positions and speeds of other vehicles driving in the lane and neighboring lane) obtained by the environmental condition estimating part 11 through the external sensor 21, and the internal information (vehicle speed, yaw rate, and acceleration) obtained by the internal sensor 22.

The automated driving controller 10 (vehicle control part 13) estimates the speed, attitude, and lateral displacement of the vehicle after At seconds from a relationship between a yaw rate γ and lateral acceleration (d²y/dt²) occurring due to vehicle movement by the vehicle's own position and movement characteristics of the vehicle itself, that is, a front wheel steering angle δ occurring when a steering torque T is applied to the steering mechanism 41 during traveling at a vehicle speed V, gives a steering angle command that makes the lateral displacement to “yt” after Δt seconds to the EPS controller 31 via the LKA controller 15, and gives a speed command that makes the speed to “Vt” after Δt seconds to the ACC controller 14.

During partially automated in-lane driving, the automated driving controller 10 recognizes a vehicle ahead in the lane and lane markings of the lane by the external sensor 21 and constantly monitors the vehicle itself to follow the generated target path.

Although the ACC controller 14, LKA controller 15, EPS controller 31, engine controller 32, and ESP/ABS controller 33 operate independently of automatic steering, they are also operable according to command input from the automated driving controller 10 while a partially automated in-lane driving function (PADS) is operating.

The ESP/ABS controller 33 that has received a deceleration command from the ACC controller 14 issues a hydraulic command to an actuator and controls braking force of the brake 43 to control the vehicle speed. In addition, an engine controller 32 that has received an acceleration/deceleration command from the ACC controller 14 controls an actuator output (degree of throttle opening) to give the engine 42 a torque command and controls driving force to adjust the vehicle speed.

The ACC function (ACCS) functions with combination of hardware and software, such as the millimeter wave radar as the forward detection means 211 included in the external sensor 21, ACC controller 14, engine controller 32, and ESP/ABS controller 33.

That is, in a case in which there is no vehicle ahead, the ACC function performs constant speed cruise by setting a cruise control set speed as the target speed; and in a case of having caught up with the vehicle ahead (in a case in which a speed of the vehicle ahead is slower than the cruise control set speed), the ACC function performs following cruise following the vehicle ahead while maintaining an inter-vehicle distance corresponding to a time gap (inter-vehicle time=inter-vehicle distance/speed of vehicle) set in accordance with the speed of the vehicle ahead.

The LKA function (LKAS) detects the lane markings and the vehicle's own position by the environmental condition estimating part 11 of the automated driving controller 10 on the basis of image data obtained by the external sensor 21 (cameras 212 and 215), and performs steering control by the LKA controller 15 and EPS controller 31 so as to be able to drive at a lane center.

That is, the EPS controller 31 that has received the steering angle command from the LKA controller 15 refers to a vehicle speed-steering angle-steering torque map, issues a torque command to an actuator (EPS motor), and gives a front wheel steering angle targeted by the steering mechanism 41.

The partially automated in-lane driving function (PADS) is implemented by combining longitudinal control (speed control and inter-vehicle distance control) by the ACC controller 14 and lateral control (steering control and lane keeping driving control) by the LKA controller 15 as described above.

### System Limit Detection and Monitoring

The ACC function (ACCS) and LKA function (LKAS) each have a system operational design domain defined within which the system can stably operate, and during the operation of the partially automated in-lane driving function (PADS), the environmental condition estimating part 11 constantly monitors whether the vehicle state is within a system limit on the basis of the external information (lanes, vehicle position, positions and speeds of other vehicles driving in the lane and the neighboring lane, and road structure) obtained through the external sensor 21 and the vehicle information (vehicle speed, yaw rate, acceleration, lateral acceleration, and steering angle) obtained by the internal sensor 22.

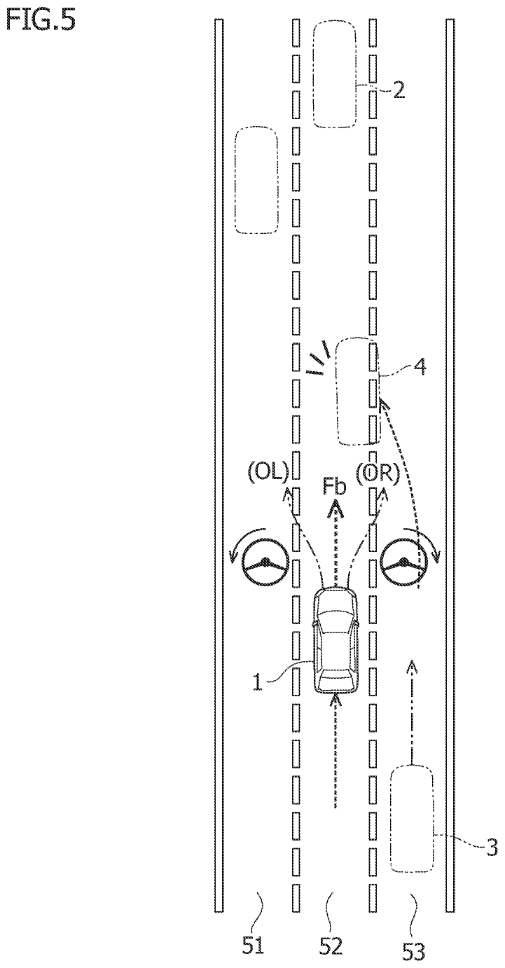

For example, a situation that brings the system limit to the ACC function (ACCS) includes when a set limit value allowing for continuation of inter-vehicle distance keeping control is exceeded by cutting-in of a vehicle 4 driving in a neighboring lane during inter-vehicle distance maintenance control with a preceding vehicle 2 as shown in FIG. 5 or when the set limit value allowing for continuation of inter-vehicle distance keeping control is exceeded due to sudden braking of the preceding vehicle 2.

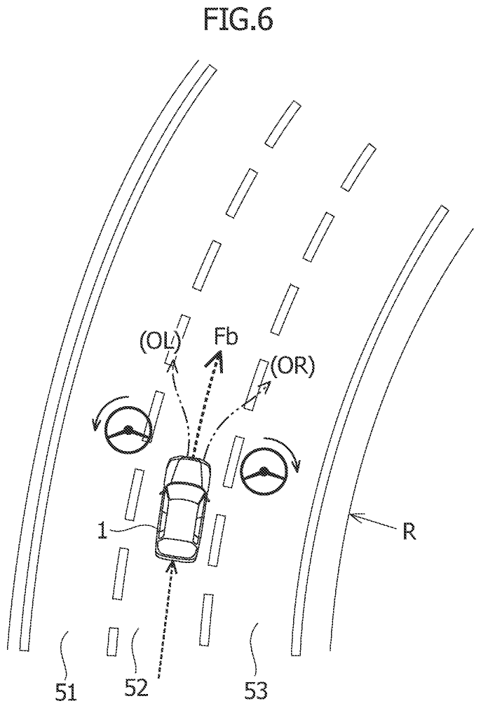

As shown in FIG. 6, if a curvature of a curve (1/R) with respect to vehicle speed exceeds a control limit value, it becomes difficult to perform constant cruise according to the target speed. The curvature of a curve can be estimated from a road shape (lanes and lane markings) obtained by the environmental condition estimating part 11 through the external sensor 21 and a target path generated by the path generating part 12 on the basis of the road shape. The curvature of a curve can also be directly calculated from coordinate point data on a curve section obtained from the map information 23, and the curve section can be identified on the basis of the absolute position of the vehicle itself detected by the positioning means 24 such as the GPS.

It also becomes difficult to continue the ACC function when the ESP (vehicle behavior stabilization control system/skidding prevention device) is activated by a slippery road surface condition due to rainfall, snowfall, freezing road, or the like. The ESP/ABS controller 33 stabilizes the posture of the vehicle and prevents skidding by matching an actual turning speed obtained from the yaw rate with a turning speed corresponding to the steering angle by brake control of each wheel, and the ACC function is stopped when the ESP is activated.

The curvature of a curve (1/R) affects lateral acceleration and is also an environmental condition that brings a system limit to the LKA function (LKAS), and the LKA function is stopped if the curvature of the curve (1/R) or lateral acceleration is a predetermined value or more.

### Override Function

During the operation of the partially automated in-lane driving function (PADS), both longitudinal control system (ACCS) and lateral control system (LKAS) can be overridden by the driver.

The longitudinal control system (ACCS) is overridden if an engine torque request by accelerator pedal operation of the driver or a deceleration request by brake pedal operation is equal to or greater than a corresponding override threshold value. These override threshold values are set to an accelerator operation amount (engine torque command value) or a brake operation amount (ESP hydraulic command value) based on which it is determined that the driver has intentionally performed acceleration/deceleration operation, and both are set according to the acceleration/deceleration characteristic and driving state of the vehicle.

The lateral control system (LKAS) is overridden if a steering torque by the driver's manual steering 34 is equal to or greater than the override threshold value. The override threshold value by the steering intervention is set according to the steering characteristic and driving state of the vehicle.

That is, the steering override stops LKA control if an operation amount or operation speed based on which it is determined that the driver has performed steering with an intention of additive steering (in the same direction) or subtractive steering (in the opposite direction) with respect to the control steering torque is applied to a steering system, and shifts to driving by the driver's manual steering.

### Shift to LKA Fallback Control Mode at ACCS System Limit

During the operation of the partially automated in-lane driving system (PADS), if the ACCS system limit is reached caused by sudden deceleration of a preceding vehicle, cutting-in of a vehicle driving in a neighboring lane, driving path curvature with respect to vehicle speed reaching the control limit value, activation of the ESP on a slippery road surface, or the like, the ACC function is stopped at the same time as the system limit, and the LKAS shifts to a fallback control mode. At the time, the driver is notified of ACC function stop, LKAS function stop advance notice, and an operation takeover request (takeover request), and LKA fallback control is started after the elapse of a prescribed waiting time (for example, four seconds).

The LKAS fallback control gradually decreases a steering torque command value (steering angle command) input into the EPS controller to 0 Nm with a predetermined inclination. When the LKAS fallback control ends, the steering operation is taken over by the driver.

As described above, when the ACCS system limit has been reached during the operation of the partially automated in-lane driving function, control is shifted to LKA fallback control together with ACC function stop, the lateral control is taken over by the driver; and at that time as already described above, excessive steering intervention (LKA override) by the driver who has been overwhelmed by the system limit notice (LKA function stop advance notice and takeover request notice) may cause lane departure, an impact on following vehicles, meandering, and the like.

### Excessive Steering Prevention Function at ACCS System Limit

The automated driving controller 10 according to the present invention has an excessive steering prevention function that, at the time of ACC and LKA function stop and takeover of steering and braking/driving by the driver when the ACCS system limit has been reached during the operation of the partially automated in-lane driving function, changes the LKA override threshold values to a value greater than during normal operation within the system limit in a period from the partially automated in-lane driving function stop (LKA function stop advance notice) to the LKA function stop (for example, elapse of four seconds after notification-LKA fallback control start-LKA fallback control end).

By increasing the LKA override threshold values at the time of ACCS system limit, an override state is avoided and the LKA control is continued, thereby sudden steering is suppressed, and lane departure, meandering, and the like can be avoided even if the driver who has been overwhelmed by the system limit notification performs steering intervention and applies a large operation amount that would lead to sudden steering before threshold value change.

### Steering Override Threshold Value within ACCS System Limit/during Normal Operation

For an additive steering override threshold value during normal operation when the ACCS is within the system limit, a steering torque (steering torque calculated from the vehicle speed-steering angle-steering torque map) corresponding to a steering angle by which a virtual lateral displacement “y’t” for reaching a virtual lateral position after “t” seconds becomes “yt+α” is set as an additive steering override threshold value T1d, where “α” is a constant determined based on vehicle speed.

In the case of subtractive steering, a value that is perceptible (determined by the steering angle, steering angle speed, or the like) and is applied in a direction of reducing the steering torque to a value (steering torque target value) obtained by converting a steering angle by which a virtual lateral displacement “yt” for reaching a virtual lateral position after “t” seconds becomes “yt+α” into a steering torque is set as a subtractive steering override threshold value T2d, where “α” is a constant determined based on vehicle speed.

### Steering Override Threshold Value at ACCS System Limit

For an additive steering override threshold value, a value obtained by converting a steering angle calculated from virtual lateral displacement “y”t” (=yt+β, where β>α) at the time of system limit and the movement characteristics of the vehicle with respect to the virtual lateral displacement “yt” within the ACCS system limit/during normal operation into a steering torque is set as an additive steering override threshold value T1L.

For a subtractive steering override threshold value, a value obtained converting a steering angle calculated from virtual lateral displacement “y”t” (=yt−γ, where “γ” is greater than a lateral displacement corresponding to a steering torque X′ Nm) at the time of system limit and the movement characteristic of the vehicle with respect to the virtual lateral displacement “yt” within the ACCS system limit/during normal operation into a steering torque is set as a subtractive steering override threshold value T2L.

### LKA Override Threshold Value Change Flow at ACCS System Limit

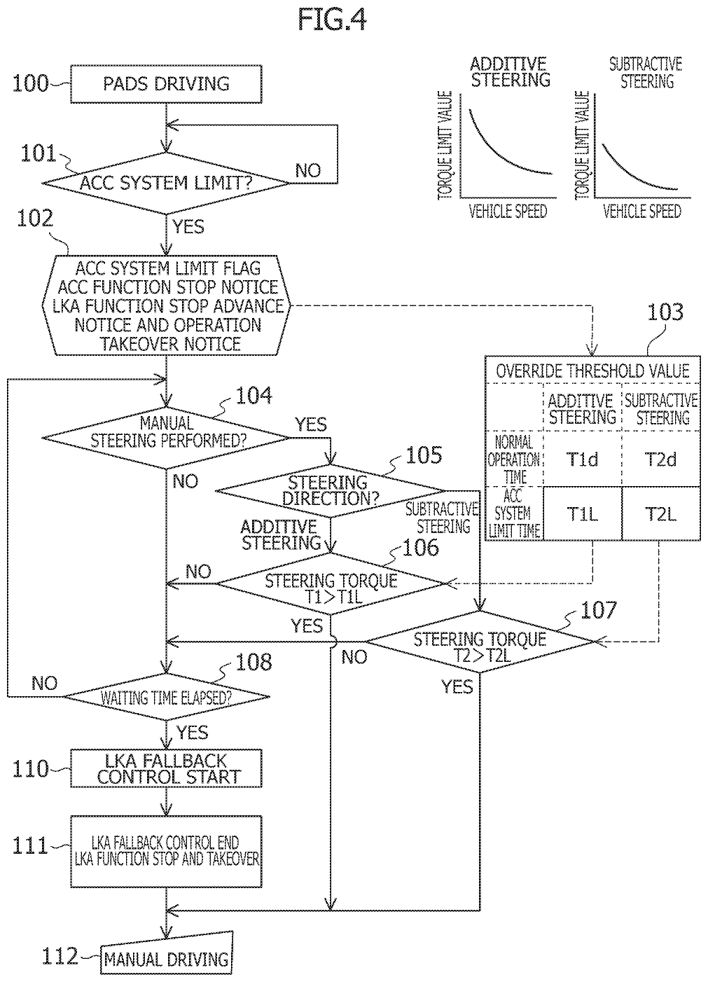

Next, an LKA override threshold value change flow at the time of ACCS system limit will be described with reference to FIG. 4.

### (1) Driving by Partially Automated In-Lane Driving System (PADS Driving)

When PADS driving is selected by the driver's operation, the ACCS and LKAS are activated after a system check, being PADS driving is displayed in the meter panel or the like (step 100). During PADS driving, the ACCS and LKAS work together, and perform constant speed cruise at the target speed (cruise control set speed) keeping within a single lane or perform following cruise maintaining the predetermined inter-vehicle distance. In this case, the target path within a lane is set to the center of the lane (driving lane), the predetermined offset distance from a left or right lane marking, or the like.

### (2) ACCS System Limit Determination

During PADS (ACCS and LKAS) driving, it is constantly monitored whether the state of the vehicle is within the system limit by the external sensor 21 and internal sensor 22 (step 101).

### (3) ACCS System Limit

During PADS (ACCS and LKAS) driving, if it is determined that the ACCS system limit is reached caused by sudden deceleration of a preceding vehicle, cutting-in of a vehicle driving in a neighboring lane, the curvature of a curve with respect to vehicle speed reaching the control limit value, activation of the ESP on a slippery road surface, or the like an ACCS system limit flag is set (step 102).

### (4) ACCS Function Stop Notice, LKA Function Stop Advance Notice, and Steering Takeover Notice

At the same time, the driver is notified of the occurrence of ACCS system limit, and accompanying ACC function stop, LKA function stop advance notice, and operation takeover request by display in a head-up display or meter panel or voice; counting of a waiting time (for example, four seconds) until shift to LKA fallback control is started.

### (5) LKA Override Threshold Value Change

At the same time, the steering override threshold values (additive direction T1d and subtractive direction T2d) within system limit/during normal operation are altered to the steering override threshold values (additive direction T1L and subtractive direction T2L) at the time of system limit (step 103).

That is, a value is calculated that is obtained by converting a steering angle calculated from lateral movement distance “yt” at this time point and the movement characteristics of the vehicle into a steering torque, and the steering override threshold values (additive direction T1L and subtractive direction T2L) at the time of system limit are set.

### (6) Determination of Whether Manual Steering Is Performed

At the same time, whether manual steering 34 is performed is determined with a torque sensor attached to the EPS controller 31 (step 104).

### (7) Steering Direction Determination

When it is determined that manual steering is performed from a detection value of the torque sensor attached to the EPS controller 31, a steering direction of the manual steering 34 is determined (step 105).

For the determination of the steering direction, it is determined to be additive steering if the torque is applied to the steering torque value calculated in the step 103 in a direction of increasing the steering torque, and it is determined to be subtractive steering if the torque is applied in a direction of decreasing the steering torque.

### (8) Override Determination

It is determined whether the steering torque of the manual steering 34 exceeds the override threshold value.

### (8-1) Additive Steering Override Determination

If the steering direction is determined to be additive steering in the steering direction determination, the steering torque is compared with the additive steering override threshold value T1L (step 106).

i) If the steering torque>the additive steering override threshold value T1L, it is determined that the operation is override and the override is carried out immediately, shifting to manual driving.

ii) If the steering torque<the additive steering override threshold value T1L, the override is not carried out, and LKA driving continues.

### (8-2) Subtractive Steering Override Determination

If the steering direction is determined to be subtractive steering in the steering direction determination, the steering torque is compared with the subtractive steering override threshold value T2L (step 107). i) If the steering torque>the subtractive steering override threshold value T2L, it is determined that the operation is override, and the override is carried out immediately, shifting to manual driving. ii) If the steering torque<the subtractive steering override threshold value T2L, the override is not carried out, and LKA driving continues.

### (9) Determination of Takeover Elapsed Time-LKA Fallback Control Start

In the case of continuing LKA driving, counting of an elapsed time from issuing the steering takeover notice in the step 102 is continued (step 108), and LKA fallback control is started after the waiting time (four seconds) passes (step 110).

### (10) LKAS Fallback Control End, Function Stop, and Steering Takeover

The steering torque command value input into the EPS controller is gradually decreased to 0 Nm with the predetermined inclination. When the LKA fallback control ends, the LKA functions are stopped and operation takeover to the driver is performed (step 111), shifting to manual driving by the driver (step 112).

Although override by excessive steering at the time of ACCS system limit can be basically prevented by the override threshold value change as described above, if the manual steering is equal to or greater than the override threshold value in the above-described override determination (steps 106 and 107), the LKA function will be overridden by the manual steering.

When the override threshold value at the time of ACCS system limit is altered (step 103), by changing an upper limit value of the steering torque or steering angle (in inverse proportion to vehicle speed/decreases as vehicle speed increases) set according to vehicle speed by the EPS controller 31 to a value lower than during normal operation within the system limit, excessive steering can be prevented when it is overridden by the manual steering.

When the override threshold value at the time of ACCS system limit is altered (step 103), by changing a steering gain of the manual steering to a small value by the EPS controller 31, it is also possible to partially reflect the steering amount on the steering torque when it is overridden by the manual steering.

### Operation and Effects

As detailed above, because the driving control apparatus for the vehicle according to the present invention is configured so that the override threshold values serving as a determination criterion of operation intervention for stopping the LKA function if the ACCS system limit is reached during the operation of the partially automated in-lane driving system (PADS) are altered to a value greater than during normal operation within the system limit, even if the driver who is overwhelmed by the system limit notice (ACC function stop notice, LKA function stop advance notice, and operation takeover notice) performs excessive operation intervention (additive/subtractive steering), override is avoided, which enables shift to fallback control in the state of continuing the LKA function, can prevent lane departure, induction of deceleration or lane change of other vehicles, and meandering of the vehicle due to excessive operation intervention, and is advantageous in smooth operation takeover.

Because the override threshold values at the time of ACCS system limit are kept from the notification of the LKA function stop and the operation takeover to end of the fallback control, operation takeover can be gradually performed in a state in which steering control by the LKA function is partially active, smooth operation takeover can be performed, and in addition, because the override threshold value during normal operation is restored when LKA fallback control is finished and shift to manual driving is completed, and thereby, the state of being capable of override by operation intervention during normal operation is immediately reached when it is returned to within the ACCS system limit.

In the above-described embodiment, the embodiment has exemplified the case in which the steering override threshold value is set based on the steering torque, the steering override threshold value can also be configured to be set based on the steering angle, steering angle speed, or the like.

Although some embodiments of the present invention have been described above, the present invention is not limited to the embodiments, various modifications and changes are possible within the scope of the present invention.

What is claimed is:

1. A driving control apparatus for a vehicle, comprising:
an environmental condition estimating part including a surrounding recognition function for recognizing a vehicle's driving lane and other vehicles driving in the driving lane and a function for obtaining the vehicle's moving state;
a path generating part for generating a target path on the basis of information obtained by the environmental condition estimating part; and
a vehicle control part configured to perform speed control for keeping a preset target speed or target inter-vehicle distance with a preceding other vehicle and steering control for causing the vehicle to follow the target path, and having:
an ACC function for performing constant speed cruise according to the target speed when there is no preceding other vehicle in the vehicle's driving lane and performing following cruise by maintaining the predetermined inter-vehicle distance when there is a preceding other vehicle;
an LKA function for maintaining cruise in the vehicle's driving lane by following control to the target path;
an override function for stopping the ACC function and the LKA function by a driver's operation intervention; and
a function for performing fallback control of the LKA function, with notifying the driver of ACC function stop, LKA function stop advance notice, and operation takeover, at a time of system limit of the ACC function,
characterized in that LKA override threshold values serving as a determination criterion of the operation intervention for stopping the LKA function at the time of system limit of the ACC function are configured to be altered to a value greater than during normal operation when the ACC function is within the system limit.

2. The driving control apparatus for the vehicle according to claim 1, wherein the system limit of the ACC function is determined on the basis that a set limit value is exceeded due to cutting-in of a vehicle driving in a neighboring lane or sudden braking of a preceding vehicle.

3. The driving control apparatus for the vehicle according to claim 1, wherein the system limit of the ACC function is determined on the basis that a curvature of a curve with respect to vehicle speed exceeds a set limit value.

4. The driving control apparatus for the vehicle according to claim 1, wherein the system limit of the ACC function is determined on the basis of activation of an ESP (vehicle behavior stabilization control system) caused by a road surface condition.

5. The driving control apparatus for the vehicle according to claim 1, wherein the LKA override threshold values include LKA override threshold values composed of an additive steering override threshold value and/or a subtractive steering override threshold value serving as a determination criterion of steering operation intervention.

6. The driving control apparatus for the vehicle according to claim 1, wherein the LKA override threshold values at the time of system limit of the ACC function are configured to be kept from the notification of LKA function stop and operation takeover to end of the fallback control.
